(19) United States
(12) Patent Application Publication
(10) Pub. No.: US 2023/0141156 A1
(43) Pub. Date: May 11, 2023

(54) RETRACTABLE STEP FOR USE AT HOME AND OFFICE

(71) Applicant: Emilio Jaime RUBIO GARCÍA, Reinach (CH)

(72) Inventor: Emilio Jaime RUBIO GARCÍA, Reinach (CH)

(21) Appl. No.: 17/735,950

(22) Filed: May 3, 2022

(30) Foreign Application Priority Data
Nov. 10, 2021 (ES) 202132226

(51) Int. Cl. E06C 1/00

(52) U.S. Cl. CPC E06C 1/005

(57) ABSTRACT

It is intended to be used as a false drawer integrated in a drawer chest, screwed to the wall, which needs to have sufficient strength to hold the weight of the structure.

Can be implemented without consuming actual current usable space, so unnecessary use of extra space by external devices is avoided. Exceeds the mark of 50 centimeters and can reach even higher. The design mirrors the CE requirements.

It consists of a rigid structure that supports 3 steps which can fold and is integrated in a chest of drawers.

### INDUSTRIAL APPLICATION

Usable space at home is a critical element, regardless of the size of the house.

Even the people living in big mansions, eventually end up having problems to store everything that accumulates in a lifetime which is difficult to get rid-off for different reasons.

Even so more often, furniture producers design ingenious modular solutions to enable further storage of clothing or else, which will not be used immediately. There is a clear trend in the market pushing towards the improved use of the space in height, which implies that it is not always easy to access belongings and therefore, we have to make use of external tools, such as chair, stools or ladders.

The installation of wardrobes of great height to make good use of higher ceilings is something more and more frequent in the current design of furniture for households, as well as for offices.

In addition, the height of some people, as well as children, makes it more difficult to reach certain high places at home or in the office.

Despite there are alternatives such as stools, steps, fixed or movable ladders, etc. all of them present the inconvenience of space consumption as well limits in their reach. Most of them cannot be over dimensioned and present the clear problem of where to be stored when not in use. On top of that, most of them can carry additional burden in terms of safety of use, due to the fact that they have not been design for such use, potentially being a hazardous source for accidents.

### Prior Technique Status

The invention is directed towards its use as an integrated step stool at home and office spaces. Specifically, it is geared towards its use as an integrated autonomous stool. In such design way, the use of unnecessary storage space or not-fit-for-purpose devices is avoided.

There are several patents, such as FR2972621, GB2462462 or US2015001005 that describe objects type stool or steps to access spaces in height. However, all of them summarize in a couple of steps, attached to the floor through some legs and that end up occupying more space that its own. Our invention is simpler and has visible advantages in its use and manufacturing.

### EXPLANATION OF THE INVENTION

The invention is directed towards its use as an integrated step stool at home and office spaces and its intended use is a false drawer integrated in a drawer chest, screwed to the wall, which needs to have sufficient strength to hold the weight of the structure.

The invention is integrated and can be implemented without consuming actual current usable space, so unnecessary use of extra space by external devices is avoided. Invention exceeds the mark of 50 centimeters and can reach even higher. The design mirrors the CE requirements.

It consists of a rigid structure that supports 3 steps which can fold and is integrated in a chest of drawers and operates when the user decides.

### BRIEF DESCRIPTION OF DRAWINGS

FIG. 1 shows the invention in its open position with the components narrative.

FIG. 2 shows a perspective of the same invention with a posterior view.

### DETAILED EXPLANATION

This retractable model is formed by a movable structure as well as 3 steps meeting with the CE normative for stools. The invention is embedded, within regular guides of a regular drawer, inside a chest of multiple drawers, being one them the invention, which when pulled out, will unfold and will be positioned ready to be used. Once out of its folded position, the structure is secured due to its interaction in between the invention and the chest of drawers, avoiding unexpected movements from the invention. The invention is installed at its height of use, and attached to the furniture by the drawer guides, thus, enabling voluntary folding and or unfolding to the user wishes.

The support structure presents a dual role, supporting the weight of the user plus cargo up to 180 kg (limited to 180 kg for safety reasons), as well as the drawers.

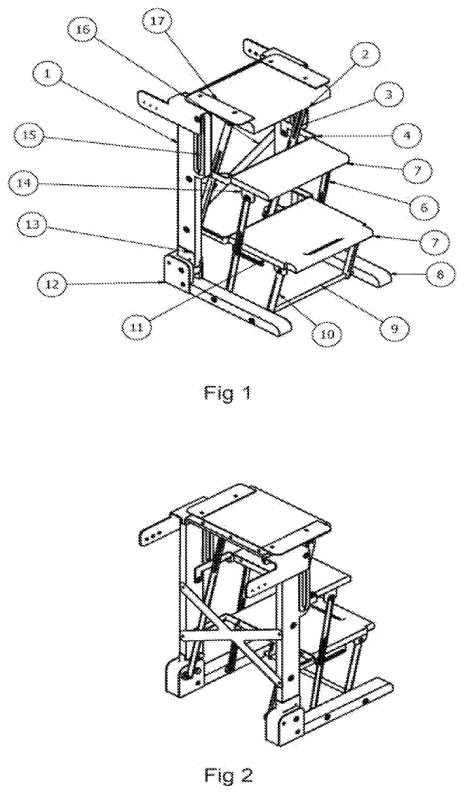

Refer to FIG. 1 for the detailed components of the invention.

The vertical leg, 1, serves as support for the structure, holding up the steps, all performed through the components, 4. There is a long strip, 3, uniting it to the third step, 5, which enables to reach highest extension. The vertical leg, 1, has a metallic reinforcement, 13, which helps the support of the structure weight, as well as a reinforcement for the rail, 15, and the cross-piece, 16, which adds better stability to the support structure.

There are 2 cylindrical supports, upper, 2, and lower, 9, which enables the turn respective to the strips, log, 3, and small, 10. The long strip, 3, is joint to the steps support, 4, which enables extension of steps, third, 5, and middle, 7, reaching maximum longitude. The latter joint allows for the relative displacement in between them, so the invention masked as a drawer can open comfortably.

The third step, 5, is united to the support of steps, 4, and the strip of the second step, 6, through the connection of the L plates, 14, of the step, which they are simultaneously connected to the small strip, 10, and the guide, 11, enabling the movement between them, and its maximum extension, activating a small stop to avoid backward movements.

In the lower part, we have a horizontal leg, 8, connected to the strip of the second step, 6, the cylindrical lower support, 9, the small strip, 10 and the metallic reinforcement, 12.

Once in its final position, pieces are fixed through screws, creating a rectangular structure with all its components, granting the invention high level of solidity, stability and resistance. The weight of the user and eventual cargo in second and third step is of great stability thanks to the pair of forces neutralized.

1. The invention is formed by a rigid metallic structure and steps, characterized because the complete structure and the three steps are embedded in regular guides within the interior of a furniture with multiple drawers, being one of these drawers the one that masks the invention.

2. This invention, according to point 1, is characterized because when unfolded and placed in the position of use, its is ready and secured blocking the structure and other drawers through the interaction of the structure and the chest of drawers.

3. A characteristic of the invention, according to point 1, is that it rotates, folding and unfolding, through some strips and a cross-piece, and the system can run along through the guides into the chest of drawers, which allows the invention be integrated as part of the furniture.
